(19) United States
(12) Patent Application Publication
(10) Pub. No.: US 2019/0332656 A1
(43) Pub. Date: Oct. 31, 2019

(54) ADAPTIVE INTERACTIVE MEDIA METHOD AND SYSTEM

(71) Applicant: Sunshine Partners, LLC, Concord, MA (US)

(72) Inventors: Sonal Chatter, Concord, MA (US); Mukesh Chatter, Concord, MA (US)

(73) Assignee: Sunshine Partners, LLC, Concord, MA (US)

(21) Appl. No.: 14/212,252

(22) Filed: Mar. 14, 2014

Related U.S. Application Data
(60) Provisional application No. 61/787,588, filed on Mar. 15, 2013.

(51) Int. Cl. G06F 17/24

(52) U.S. Cl. CPC G06F 17/24

(57) ABSTRACT

An automated adaptive engine alters content in real-time based on feedback received. With this engine human adjustment is no longer necessary or is kept to minimum by choice. The engine may build an Emotional Profile (EP) from scratch, may modulate an existing EP based on detected real-time responses, or also may randomly try different things to detect new response from the user. The engine may be applied with an interactive media application, preferably embodied as an interactive book, that adjusts content automatically in real-time, based on a reader's quality of emotional response (or mental response) against expectation, without requiring any human intervention. The response feedback is detected as expressed through voice, facial expressions, vitals such as pulse or blood pressure, and/or activities in different parts of the brain, or other means of such expression.

### CROSS-REFERENCE TO RELATED APPLICATIONS

This utility patent application claims priority from U.S. provisional patent application Ser. No. 61/787,588, filed Mar. 15, 2013, titled “ADAPTIVE INTERACTIVE MEDIA METHOD AND SYSTEM” in the name of SONAL CHATTER and MUKESH CHATTER.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2014 Sunshine Partners, LLC.

### BACKGROUND

### Field of Technology

This disclosure relates to media, and more particularly to interactive and automatically adaptive media including electronic books.

### Background

Today books are static objects. One reads what is written and it stays the same regardless of the reader's reactions or wish to change things. Books in general do not change once written. Some of the more recent versions of electronic books, at times, allow different paths to follow based on input selected by the reader. The reader may pick a fork provided by the story writer in anticipation of liking that path. There are no means currently available to adjust the content in real-time based on the reader's continuous voluntary or involuntary feedback.

None of the known prior art provides an interactive book which adjusts its content 1) automatically in real-time 2) based on a reader's quality of emotional or mental response, and 3) without requiring any human intervention. What is needed, therefore, is a solution that overcomes the above-mentioned limitations and includes the features enumerated above.

### BRIEF SUMMARY

Disclosed herein is an interactive media application, preferably embodied as an interactive book, that adjusts its content automatically in real-time, based on a reader's quality of emotional response (or mental, or physiological response, or via sounds, voices or facial expressions—the words have been used interchangeably throughout the document but deemed to include one or more of the above) relative to expectation or measured in an absolute manner relative to itself, without requiring any human intervention. Emotional response feedback is expressed through voice, facial expressions, vitals such as pulse or blood pressure, and/or activities in different parts of the brain, or other means of such expression.

An automated adaptive engine alters content in real-time based on feedback received. With this engine human adjustment is no longer necessary. The content may already have response expected from the users built into it or it may not. The engine may build an Emotional Profile (EP) from scratch, may modulate an existing EP based on detected real-time responses, or also may randomly try different things to detect new response from the user. If the EP is not provided, the feedback may be relatively measured against itself if it is not necessary, or, possible, or desirable to build EP. Such a system has the following features and benefits:
Identify Emotional Response (ER) points, if any, and their relative and absolute value
Measurement of ER may include, but is not limited to, amplitude, range, and duration to a set of stimuli within a type of emotion
Creation of EP using various types of stimuli across varieties of emotions
The absolute measurements so made may also be scaled on a relative basis to a common set across wider population base
EP may also be measured over a longer period of time to allow for short term variance in responses to be used as a transient modulating influence
Enables optimum mating of content to unique EP resulting in optimized user experiences
Enables content delivery to maximize swings from one Emotional Resonance (ERSO) to another thus enhancing the full user experience

### BRIEF DESCRIPTION OF THE DRAWINGS

In the drawings, closely related figures and items have the same number but different alphabetic suffixes. Processes, states, statuses, and databases are named for their respective functions.

FIG. 1 is a system diagram of showing a consumption device connected to multiple types of input devices.

FIG. 2 is a flowchart showing multiple types of input into an adaptive engine connected to modifiable dynamic content.

FIG. 3 is a flowchart showing the process of dynamic content modifications based on Emotional Profiles.

### DETAILED DESCRIPTION INCLUDING THE PREFERRED EMBODIMENT

### Terminology

The terminology and definitions of the prior art are not necessarily consistent with the terminology and definitions of the current invention. Where there is a conflict, the following definitions apply.

Three different types of human actors may be involved at various points. Content creators, such as authors, are responsible for creating consumable content and variations, choices, or possible ranges for variation within the content. Users, referred to herein interchangeably as readers or viewers, are consumers of the content. Consuming content is the act of accessing and processing the content, such as viewing (including reading, watching, or looking at), listening, smelling, or other sensory act. Administrators are responsible for managing and configuring any technical system involved in delivering and managing the content presented to users. Responses to content can be recorded and used to characterize an individual user's profile. The profile records the user experience for a range of content. For each input to the user (content offered to user), the resulting measured response is defined as Emotional Response (ER) for that specific type of input. The content at which peak amplitude of the state is observed is the point of Emotional Resonance (ERSO) for a specific type of content scenario. This quantifies how an individual responds to different types of content, such as laughing versus crying versus jumping up and down. Compilation of such characterization for one or more of such scenarios is defined as Emotional Profile (EP).

### Operation

In the following detailed description of the invention, reference is made to the accompanying drawings which form a part hereof, and in which are shown, by way of illustration, specific embodiments in which the invention may be practiced. It is to be understood that other embodiments may be used, and structural changes may be made without departing from the scope of the present invention.

There are multiple components which may be configured in various embodiments. A content device component delivers content for user consumption. A rendering device component displays the content for consumption to one or more users. The display may be visual, such as text, video, and/or images; aural; olfactory; for any other form of sensory detection; or any combination thereof. A feedback device component collects emotional data from sensors observing user response to the consumed content. An analysis device component operates an automated adaptive engine to analyze the emotional data which directs any changes or control over consumed content. An optional storage device component tracks EP of one or more users. These components may be embodied on physical devices jointly, severally, or in any combination. An example of a single device embodiment may be an iPad with: content stored on the iPad (content device); content rendered for consumption by display on the iPad screen (rendering device); tracking sensors including microphone, video camera, and motion sensors within the iPad (feedback device); adaptive engine operated by an app on the iPad (analysis device); and user EP stored on the iPad (storage device). Each component may be moved separately or jointly to another device, or even to multiple devices. For example, the content may be streamed from another network connected device (content device). The display may be a television or other screen (rendering device) displaying such as through AirPlay. The tracking may be provided from multiple inputs (such as user phone) or monitoring devices connected to a user (such as a bio sensor), making the feedback device separate from the iPad or distributed across multiple devices. The adaptive engine may be run on a network connected server (analysis device), which may be particularly beneficial when accepting feedback from multiple sources or streaming/providing content over the network. The EP may be stored on a network-connected device (storage device), which may be particularly beneficial to track EP of users across multiple devices used by the individual user.

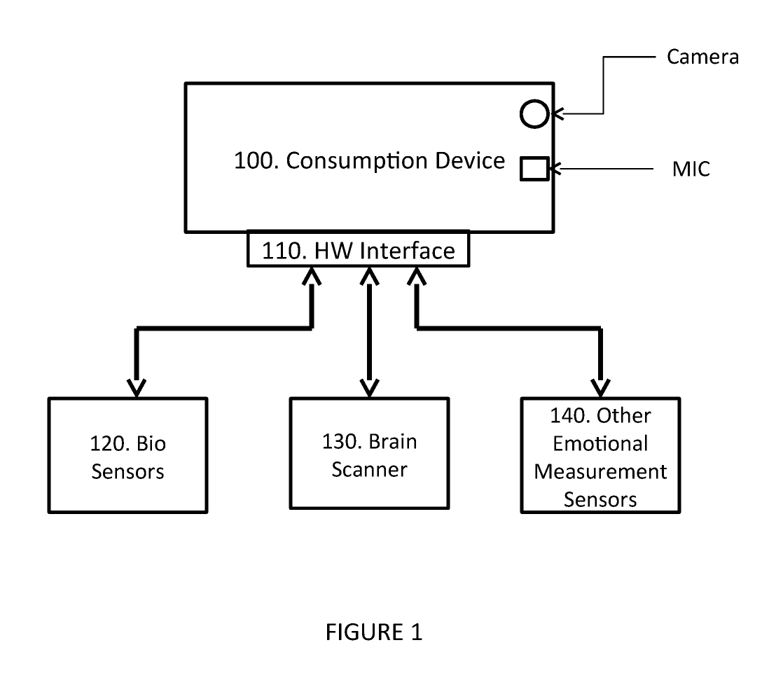

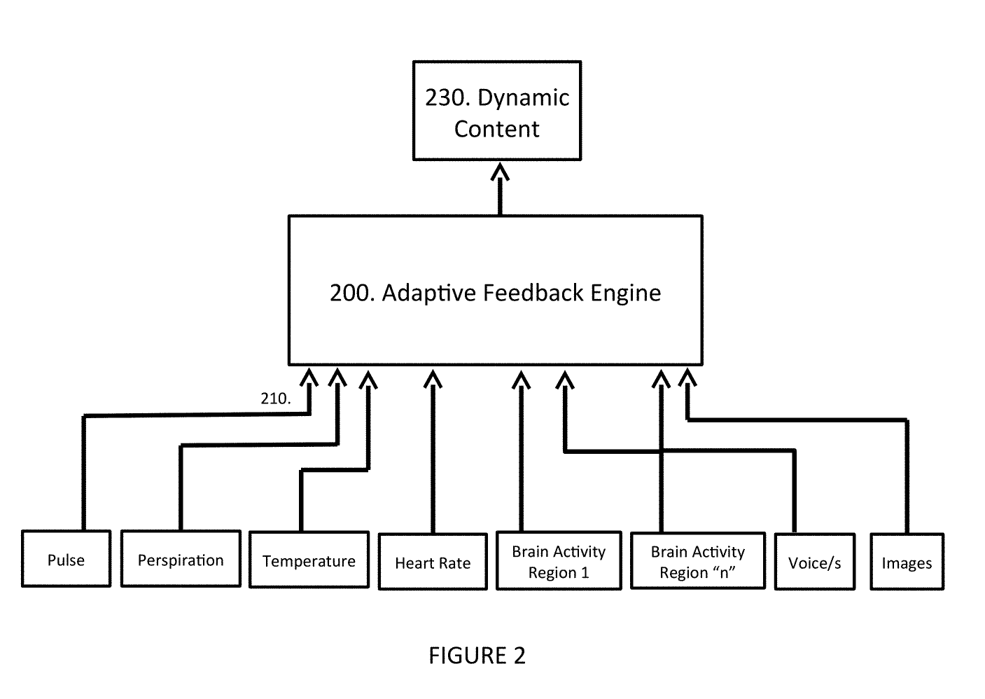

Referring to FIG. 1, in a preferred embodiment the iPad, iPhone, some PCs, even televisions and many such similar equipment, tablets or devices, wired or wireless, (consummation device 100) have a computer processor and are routinely equipped with audio and video interfaces and corresponding voice recognition and/or image recognition technologies. Consumption devices may also have standard interfaces 110 to receive data from external sources. Similarly other sources of feedback such as bio sensors 120, brain scanners 130, or other emotional sensors 140 can also be used to provide input via the standard interfaces/s or purpose built hardware. The feedback inputs may be part of or directly connected to the consumption device, indirectly connected, such as by monitoring systems which make their monitored data available over a network via a computer programming interface (API), or connected to one or more separate devices for analysis. The feedback input data may be interpreted by the automated adaptive engine as emotional response to content being consumed. Referring also to FIG. 2, the device(s) operating the automated adaptive engine require sufficient computing power to operate an automated adaptive engine 200 with appropriate inputs 210, algorithms and software. The automated adaptive engine may be operated on the consumption device or on one or more separate computing devices. This engine characterizes the response for variance in content to identify corresponding emotional feedback of the user and then automatically in real-time provides optimized content 230 appropriate to the corresponding state.

The content can be optimized in many ways. One approach is to pre-define all the possible responses like a tree where the path is selected based on detected emotion. This is essentially a rules based approach. Another approach is to modify the content dynamically. In this case content may be modified linearly or non-linearly. For example, in visual content the height a monkey jumps from a tree could be defined as a non-linear function. In some instances randomization may be used, such as for possible exploration. In this case every possible path need not be developed but instead aspects of the content or story are governed by the variables whose values are computed/updated in real-time based on the user's emotional feedback. In other cases, content optimization could be combination of one or more of the above approaches. Content being consumed may be controlled by the consumption device, such as being stored and played back from the device, or streamed through the consumption device. Content may be displayed by the consumption device, such as video on a screen of the device and/or audio through speakers of the device, or displayed under control of the consumption device, such as a video game system providing video to a television for display and/or audio to external speakers. Control of content requires options in the content, as explained above, to change the content, either statically or dynamically, in response to or anticipation of different possible emotional responses and/or different degrees of emotional responses.

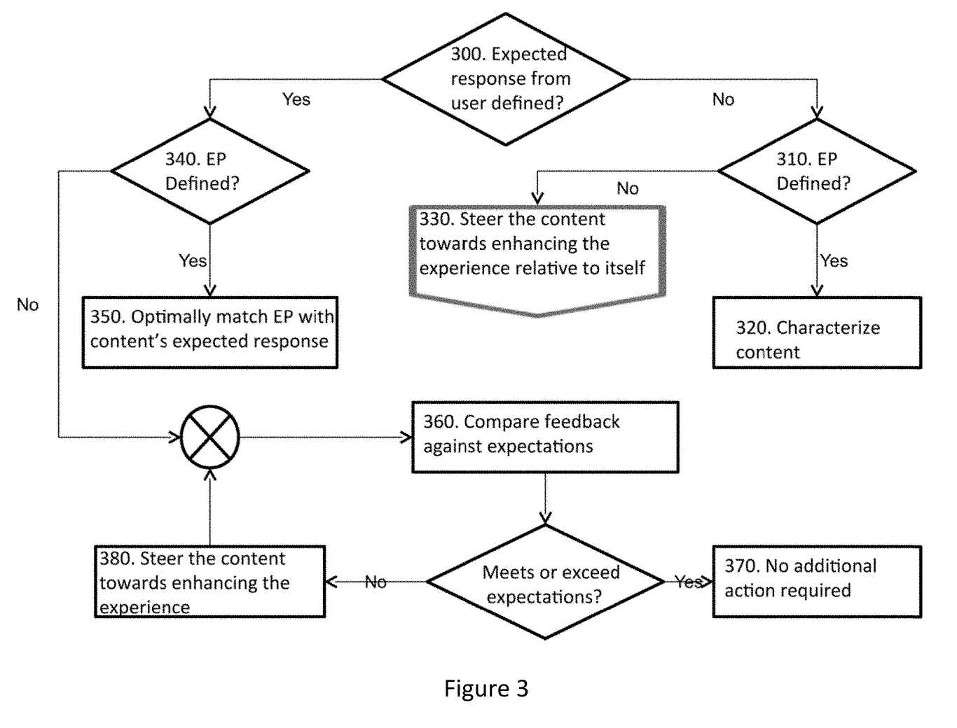

Referring also to FIG. 3, one embodiment of the adaptive engine checks current content to determine if an expected ER is defined 300 for options or possible dynamic changes at that point within the content. If not, the the adaptive engine checks if EP is defined 310. If EP is defined, the EP may be used to characterize 320 the ER elicited from that content. If EP is not defined, the content may be steered 330 towards enhancing the experience relative to itself, such as increasing humor if laughter is detected or increasing sadness if crying is detected. If expected ER is defined, the adaptive engine also checks if EP is defined 340. If EP is defined, the engine may match 350 EP with the content's expected response to dynamically optimizes the content. EP may also be updated/refined based on the existing profile, the detected feedback, and the expected response of the content. If EP is not defined, the engine compares 360 emotional response feedback with emotional response expectations. If the feedback meets or exceeds expectations, no action is taken 370 to adjust content. If feedback is below expectations, the content may be steered 380 towards enhancing the experience to better meet expected emotions.

In one example, when a user consuming a story on a Device and laughing louder at certain content, then that specific content can be identified as making the reader respond that way. The fact that the user is laughing relatively louder than at other times is recognized by the engine and correspondingly the story line is automatically adapted further to enhance this state of laughter. Similarly, repeated pictures may be taken and analyzed to identify if a person is sad, happy, scared or in another identifiable mental state. After such identification, the content may be automatically adjusted in real-time to enhance or adjust the reading or media experience. Bio-sensors may be used to measure one or more parameters such as pulse rate, perspiration, or blood pressure in response to content accessed. For example, the content may be intended to raise the heart rate, such as through chase or intense scenes. The engine may monitor and make active changes in the presented content to raise the heart rate and optimize the user experience. Similarly, brain sensors may be interfaced so that internal activity may be measured in different parts of the brain and used appropriately to optimize content in an intended direction.

As another example, a young user may be using a device to consume a story involving monkeys. The intent behind the monkey is to elicit laughs from the reader. Using cameras and microphones, the engine is able to detect if the user is laughing or not. If the expected response is received then the book continues without adjustment. If the expected response is not received, then the book automatically adjusts in real-time in order to elicit laughter. As examples of such adjustments, the monkey may be shown swinging. If already swinging, the speed of swinging may be changed. The monkey may be shown jumping higher or lower. More monkeys may be added into the scene. Other animals may be added into the scene and take actions such as swinging from tree to tree as well. Objects may be introduced for the monkey to swing and jump around, such as vines, people, houses, ponds, and other animals. The engine may dynamically adjust between multiple such options in order to achieve a desired response.

As another example, a scene may involve a character making some sound or saying some words, with the intended goal to induce user laughter. If the intended response is not happening, the engine may automatically adjust the content, for example by doing one or more of the following examples: changing the volume and/or intensity of the sound, adding on other sounds, changing the pitch, adding in the reader's voice, and more variations and combinations thereof.

In addition to the verbal responses as described above, the engine may also measure visual responses by taking pictures and analyzing them. Examples include:
If something is making a user sad and that was not the intention then the content may be changed/evolved
If a scene is supposed to make a user feel sad, however a particular user is not feeling sad, the story may adjust by adding in visual or audio information that will move the viewer toward being sadder
If a user is watching a horror movie, in certain scenes the goal may be to make the user scream. Pictures may be taken and voice recorded to determine if the user is screaming and the engine may adjust the content accordingly. Biosensors may also be used to determine breathing rate and/or pulse or perspiration or other measurable parameters to see how scared the viewer is. Alternately, if a group of individuals are watching a horror movie and a particular scene intended to be very scary is instead laughed through, using visual, audio, and biosensor information, the engine may automatically adjust the movie content in real-time and make the scene scarier so that the desired response is elicited from the users.

Multiple types of responses may be measured in order to make the appropriate adjustments. Visual responses may be tracked over time by taking pictures at certain intervals and then analyzing them. A continuous stream may also be evaluated for certain things like a smile or a frown. There are many forms of audio input that may also be measured at certain intervals. One or more of laughter, crying, screams, gasps and more may be evaluated. Biosensors may be used to measure other bodily responses such as including, but not limited to, one or more of pulse, perspiration, and temperature. As an example, if a particular TV show is horror-centric, at certain points it is intended to raise the heart rate within a safe zone. However, if the observed rise does not match the expected impact, the scary content of the scene may be automatically evolved into something that will elicit the desired response.

Each time the content evolves the feedback may be measured in real-time to see if it is evolving in the desired direction. In one of the prior examples, increasing how high a monkey jumps or the number of trees the monkey crosses may have no, little, or even negative response with a child user. In that event the story may evolve in a different direction instead of further trying options in the same domain which are not having the intended effect. In another example a child may be reading a story but not finding the current story line interesting. The storyline may be changed in order to keep the child engaged. If another child reads the story and loses interest at a different point in the story, the engine may adapt to please the new reader in a different story line than the previous reader. Therefore the same story may have multiple outcomes.

Content delivered for adaptable media may be automatically adjusted in real-time in directions which optimize the content to match the EP.

### Other Embodiments

Assuming an EP already exists for a user, there are many media applications beyond interactive books, such as general applications to “advertising.” In the case of on-line advertising, presently ads are targeted based on extensively collected profiles such as an individual's age, income, the type of car driven, location, past purchase history, search history and so on. For clarity, in this document they are collectively defined as “External Profile”. There are hundreds or thousands of such data points, and using this information to make decisions about serving an ad, in real-time, is a highly complicated and compute intensive problem. Yet the click rates on such ads are extremely low, often ranging from less than 0.01% to as high as only 1 or 2%. The ads are targeted on the idea of who is more likely to click or buy. Different ads for the same product can elicit a wide range of click through rates as they touch different chords. However, the method is highly random involving trying thousands of ads and aggregating response for each ad based on clicks to discover the best performing ads. Such ads are then targeted based on External Profile.

In sharp contrast to the above, with the disclosed system ads can be customized to each individual's unique EP to get the best response. As an example, user ‘A’ may like funny ads, but user ‘B’ responds better to ads that evoke peace and harmony, and user ‘C’ responds better to ads with loud music. Still other users may prefer ads with humans and others prefer ads with animals. For example an ad server may consider an individual user's EP and serve the corresponding ad that operates at the user's unique ER and ERSO level. Such ads may be far more persuasive and have much higher click thru rates then observed with traditional online ad serving.

In an alternative embodiment, the platform may be further enhanced by using the above described External Profile based targeting (such as age, recent searches, gender, income etc.) as a first order filter and then customizing each ad for that individual's EP. In yet another alternative embodiment, the order is reversed, ads are first sorted based on EP and then further optimized for the External Profile. In yet another alternative, a combination of EP and External Profile may be used. In alternative embodiment, EP can be a factor while computing bid for RTB (real time bidding) based advertising.

Alternatively, if a user's EP is unknown or is limited then one or more ads with varying stimuli may be served to the user and response measured, through feedback detected at the user's consumption device and analyzed at an adaptive engine, to progressively build the EP. The EP may be further refined as a function of time. As each ad is run across various users, the engine may create an average EP response for each such ad. Subsequently each ad may be uniquely modulated for additional user(s). In another alternative, once an average EP profile exists, random exploration in different directions may be used to further customize to the user. There could be many combinations of such options as well.

Thus the automated real-time adaptive engine may be used to maximize the click thru rates on ads.

In another embodiment, the engine may be used such that a TV show (any type of content including but not limited to movies, serials, reality TV, cartoons, comedy and so on) may offer variances that are customized to each viewer. As a result a person and his neighbor with different EP may see different variations of the same show.

In another embodiment, movie trailers may be used to test what evokes response from certain EP types and learn how to enhance experience in advance. For example, certain lines delivered slightly differently by an actor may evoke a significantly different ER. Thus by testing variations in advance a better movie may be produced.

The engine may also be applied in a group setting. A group goal may be to create a composite profile and then evolve the presented media in a manner optimized to the composite profile. If there are multiple people in the audience then the engine may be configured such that:
One person is the master and to only use said person's EP
Use everyone's feedback equally and incorporate the average
Relative weights are assigned to each audience member and averaged over a certain time frame. For example adults watching a cartoon show with children may have relatively lower weights than the children. The relative weights can range from 0 to 1.

Yet another application is usage of EP and/or ER in e-commerce. If EP is known such as if a consumer is an impulse buyer, then for example an attractive offer can be made in real-time.

There are many more applications including in education and others, the examples used throughout this document are for exemplary purposes only.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1-27. (canceled)

28. A method of dynamically modifying content, comprising:
consuming content through a consumption device;
operating an automated adaptive engine within a computing device having a processor;
inputting data to the computing device;
interpreting, by the adaptive engine the input data as emotional response to the content;
creating, by the adaptive engine, an emotional profile if the emotional profile does not exist;
updating, by the adaptive engine, the emotional profile based on the emotional response; and
dynamically altering, by the adaptive engine, the content being consumed based on the emotional profile, wherein dynamic alterations are further based on non-linear functions.

29. The method of claim 28, wherein the consumption device is the computing device.

30. The method of claim 28, further comprising receiving one or more inputs of emotional feedback data at the consumption device and providing the emotional feedback data as input data to the computing device.

31. The method of claim 28, where inputting data further comprises inputting data from one or more of: audio input; camera input; video input; brain sensor input; and/or bio-sensor input measuring one or more of pulse, perspiration, and/or blood pressure.

32. The method of claim 28, wherein dynamically altering further comprises adjusting the content being consumed in order to optimize the emotional response.

33. The method of claim 28, further comprising refining, by the adaptive engine, the emotional profile over time by tracking one or more emotional responses.

34. The method of claim 33, further comprising varying content, by the adaptive engine, to change stimuli and measure different responses while refining the emotional profile.

35. The method of claim 28, further comprising dynamically adjusting, based on the emotional profile, variables controlling elements within the content being consumed.

36. The method of claim 28, further comprising compositing, by the adaptive engine, the emotional profile as a group profile of multiple people consuming the content.

37. The method of claim 36, wherein compositing further comprises basing the group profile on one person from among the multiple people.

38. The method of claim 36, wherein compositing further comprises averaging individual emotional profiles of the multiple people to form the group profile.

39. The method of claim 36, wherein compositing further comprises weighting individual emotional profiles of the multiple people and averaging the weighted profiles to form the group profile.
